(19) United States
(12) Patent Application Publication
(10) Pub. No.: US 2006/0039478 A1
(43) Pub. Date: Feb. 23, 2006

(54) Image decoding and reducing apparatus and method

(75) Inventor: Shunichiro Nonaka, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/206,240

(22) Filed: Aug. 18, 2005

(30) Foreign Application Priority Data
Aug. 20, 2004 (JP) 2004-240559

(51) Int. Cl. H04N 11/04

(52) U.S. Cl. 375/240.23

(57) ABSTRACT

Image data that has undergone JPEG compression is subjected to variable-length encoding to obtain orthogonal transform coefficients. The resolution (size) of the compressed image data is acquired and, based upon the resolution of a target reduced image and the acquired resolution, some orthogonal transform coefficients to be used in an inverse transform are decided from among the orthogonal transform coefficients. The orthogonal transform coefficients decided are subjected to an inverse transform and a first reduced image is obtained. If the resolution of the obtained first reduced image is not the target resolution, the amount of data constituting the reduced image data is adjusted to obtain a second reduced image that is the target. As a result, a desired image is obtained in rapid fashion.

### BACKGROUND OF THE INVENTION

1. Field of the Invention

This invention relates to an apparatus and method for decoding and reducing images, as well as an image distribution server, a relay server for mail having attached images and an image display system, which use this image decoding and reducing apparatus.

2. Description of the Related Art

There are systems in which in response to a request from a device such as a mobile telephone, image data is transmitted to the mobile telephone and an image is displayed on the display screen of the mobile telephone. It is desired that the mobile telephone be sent image data representing an image whose size has been made to conform to the display screen of the mobile telephone. To achieve this, there is prior art in which the mobile telephone is sent image data representing an image that is suited to the size of the display screen of the mobile telephone (e.g., see the specification of Japanese Patent Application Laid-Open No. 2004-56662).

In an instance where image data that has been compressed by being subjected to an orthogonal transform and variable-length encoding according to the JPEG (Joint Photographic Experts Group) standard is decoded, variable length decoding is executed and an inverse orthogonal transform is applied. Orthogonal transform coefficients are obtained by executing the variable-length decoding processing, and decoded image data is obtained by subjecting the obtained orthogonal transform coefficients to the inverse orthogonal transform. Size reduction processing is further executed in order to make the size of the image smaller than the size of the image represented by the image data that has been obtained by decoding. This necessitates processing in two stages, namely processing for decoding the image data and processing for the size reduction. There are examples of prior art that obtain a reduced image rapidly by simplifying this two-stage processing (see the specifications of Japanese Patent Application Laid-Open Nos. 58-75390, 2-122767 and 2001-103313).

With these methods, however, there are instances where a reduced image of a desired size cannot be obtained.

### SUMMARY OF THE INVENTION

Accordingly, an object of the present invention is to obtain a reduced image of desired size.

According to a first aspect of the present invention, the foregoing object is attained by providing an apparatus for decoding and reducing an image, comprising: a variable-length decoding processing device (variable-length decoding processing means) for inputting compressed image data that has undergone an orthogonal transformation and variable-length encoding, applying variable-length decoding processing to this data and obtaining orthogonal transform coefficients; an orthogonal transform coefficient deciding device (orthogonal transform coefficient deciding means) for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by the variable-length decoding processing device; an inverse orthogonal transform device (inverse orthogonal transform means) for executing inverse orthogonal transform processing and obtaining reduced image data using the orthogonal transform coefficients decided by the orthogonal transform coefficient deciding device; and an adjusting device for adjusting amount of the reduced image data in such a manner that the size of the reduced image data represented by the reduced image data obtained by the inverse orthogonal transform device will become the image size to which a reduction is to be made.

The first aspect of the present invention also provides a method suited to the image decoding and reducing apparatus described above. Specifically, the first aspect of the present invention provides a method of decoding and reducing an image, comprising the steps of: inputting compressed image data that has undergone an orthogonal transformation and variable-length encoding, applying variable-length decoding processing to this data and obtaining orthogonal transform coefficients; deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing; executing inverse orthogonal transform processing and obtaining reduced image data using the decided orthogonal transform coefficients; and adjusting amount of the reduced image data in such a manner that the size of the reduced image data represented by the reduced image-data obtained in the inverse orthogonal transform processing will become the image size to which a reduction is to be made.

According to the first aspect of the present invention, variable-length decoding processing is applied to compressed image data that has undergone an orthogonal transformation and variable-length encoding. Orthogonal transform coefficients are obtained when the variable-length decoding processing is executed. Orthogonal transform coefficients of low-frequency components to be used in an inverse orthogonal transform are decided, based upon the size of an image represented by the input compressed image data and the image size to which a reduction is to be made, from among the obtained orthogonal transform coefficients. Inverse orthogonal transform processing is executed and reduced image data obtained using the decided orthogonal transform coefficients. The amount of data constituting the reduced image data is adjusted in such a manner that the size of the reduced image data represented by the obtained reduced image data will become the target size of the image to be downsized.

In accordance with the first aspect of the present invention, decoding processing and reduction processing can be executed efficiently and a reduced image can be obtained comparatively quickly. Since the amount reduced image data is adjusted, a reduced image of a desired size can be obtained.

According to a second aspect of the present invention, the foregoing object is attained by providing an image distribution server comprising: a compressed image data search device, which is responsive to model information of a mobile terminal and an image data request that have been transmitted from the mobile terminal, for finding corresponding compressed image data in compressed image data that has undergone an orthogonal transformation and variable-length encoding, this being image data, which is to be transmitted to the mobile terminal, stored in a compressed image data storage device; a variable-length decoding processing device (variable-length decoding processing means) for inputting the compressed image data that has been found by the compressed image data search device, applying variable-length decoding processing to this data and obtaining orthogonal transform coefficients; an orthogonal transform coefficient deciding device (orthogonal transform coefficient deciding means) for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by the variable-length decoding processing device; an inverse orthogonal transform device (inverse orthogonal transform means) for executing inverse orthogonal transform processing and obtaining reduced image data using the orthogonal transform coefficients decided by the orthogonal transform coefficient deciding device; an adjusting device for adjusting amount of the reduced image data in such a manner that the size of the reduced image data represented by the reduced image data obtained by the inverse orthogonal transform device will become the image size to which a reduction is to be made; and an image data transmitting device for transmitting the reduced image data, the amount of which has been adjusted by the adjusting device, to the mobile terminal that transmitted the image data request.

In accordance with the second aspect of the present invention, model information of a mobile terminal and an image data request are transmitted from the mobile terminal and, in response thereto, compressed image data is found in accordance with the mobile terminal. The found compressed image data is subjected to processing for producing a reduced image in such a manner that the obtained image will have a size suited to the display screen of the mobile terminal. The produced reduced image data is transmitted to the mobile terminal that transmitted the image data request. Thus a reduced image having a size suited to the display screen of the mobile terminal is displayed comparatively quickly.

The compressed image data storage device may be provided separately of the image distribution server. In a case where the compressed image data storage device and image distribution server are provided separately of each other, compressed image data would be found in the compressed image data storage device in response to the request from the image distribution server, and the found compressed image data would be transmitted from the compressed image data storage device to the image distribution server.

According to a third aspect of the present invention, the foregoing object is attained by providing a server for relaying mail with an image attachment, comprising: a separating device (separating means) for receiving e-mail transmitted from a mobile terminal and to which has been attached compressed image data that has undergone an orthogonal transformation and variable-length encoding, and separating the e-mail into the attached compressed image data and an e-mail body; a variable-length decoding processing device (variable-length decoding processing means) for inputting the compressed image data that has been separated by the separating device, applying variable-length decoding processing to this data and obtaining orthogonal transform coefficients; an orthogonal transform coefficient deciding device (orthogonal transform coefficient deciding means) for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by the variable-length decoding processing device; an inverse orthogonal transform device (inverse orthogonal transform means) for executing inverse orthogonal transform processing and obtaining reduced image data using the orthogonal transform coefficients decided by the orthogonal transform coefficient deciding device; an adjusting device for adjusting amount of the reduced image data in such a manner that the size of the reduced image data represented by the reduced image data obtained by the inverse orthogonal transform device will become the image size to which a reduction is to be made; and an e-mail transmitting device for transmitting the reduced image data, the amount of which has been adjusted by the adjusting device, and the e-mail body separated by the separating device to a transmission destination contained in the e-mail body.

In accordance with the third aspect of the present invention, e-mail having compressed image data attached thereto is received from a mobile terminal and the e-mail is separated into compressed image data and e-mail proper. Reduced image data of the appropriate size is generated, in a manner similar to that described above, from the separated compressed image data. The reduced image data thus generated is transmitted together with the e-mail body (simultaneously or separately) to the transmission destination contained in the e-mail body. Reduced image data having the appropriate size is transmitted comparatively quickly to the transmission destination contained in the body of the e-mail.

By way of example, the e-mail transmitting device transmits the reduced image data obtained by the inverse orthogonal transform device to the transmission destination contained in the e-mail body upon attaching the reduced image data to the e-mail body separated by the separating device, or transmits the e-mail body to the transmission destination contained in the e-mail body separated by the separating device and transmits the reduced image data obtained by the inverse orthogonal transform to the transmission destination in response to a request from the transmission destination.

The reduced image data is reduced image data representing a moving picture, by way of example.

According to a fourth aspect of the present invention, the foregoing object is attained by an image display system comprising: a compressed image data storage device for storing a plurality of items of compressed image data that has undergone an orthogonal transform and variable-length encoding; a compressed image data search device, which is responsive to an image display command, for finding corresponding compressed image data in compressed image data that has been stored in the compressed image data storage device; a variable-length decoding processing device (variable-length decoding processing means) for inputting the compressed image data that has been found by the compressed image data search device, applying variable-length decoding processing to this data and obtaining orthogonal transform coefficients; an orthogonal transform coefficient deciding device (orthogonal transform coefficient deciding means) for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by the variable-length decoding processing device; an inverse orthogonal transform device (inverse orthogonal transform means) for executing inverse orthogonal transform processing and obtaining reduced image data using the orthogonal transform coefficients decided by the orthogonal transform coefficient deciding device; an adjusting device for adjusting amount of the reduced image data in such a manner that the size of the reduced image data represented by the reduced image data obtained by the inverse orthogonal transform device will become the image size to which a reduction is to be made; and a display device for displaying the reduced image represented by the reduced image data obtained by the adjusting device.

In accordance with the fourth aspect of the present invention, an image display command is responded to by finding corresponding compressed image data in compressed image data that has been stored. Reduced image data is obtained in regard to the found compressed image data in the manner described above. The reduced image represented by the obtained reduced image data is displayed. Thus, a reduced image having the appropriate size is displayed on the display screen of the display device comparatively quickly Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIGS. 1 and 2 are diagrams illustrating the external appearance of an image display system;

FIG. 3 is a block diagram illustrating the electrical structure of the image display system;

FIG. 4 is a flowchart illustrating image display processing;

FIG. 5 is a flowchart illustrating processing for converting image format;

FIG. 6 illustrates orthogonal transform coefficients;

FIG. 7 illustrates an original image;

FIG. 8 illustrates a first reduced image;

FIG. 9 illustrates a second reduced image;

FIG. 10 illustrates an overview of an image distribution system;

FIG. 11 is a block diagram illustrating the electrical structure of an image distribution server;

FIG. 12 illustrates an example of a table of mobile telephones;

FIG. 13 is a flowchart illustrating processing executed by the image distribution server;

FIG. 14 is a flowchart illustrating processing for converting image format;

FIG. 15 illustrates an overview of an image distribution system;

FIG. 16 is a flowchart illustrating processing executed by the image distribution server;

FIG. 17 illustrates an overview of an e-mail distribution system; and

FIGS. 18 and 19 are flowcharts illustrating processing executed by an e-mail relay server.

### DESCRIPTION OF THE PREFERRED EMBODIMENTS

A preferred embodiment of the present invention will now be described in detail.

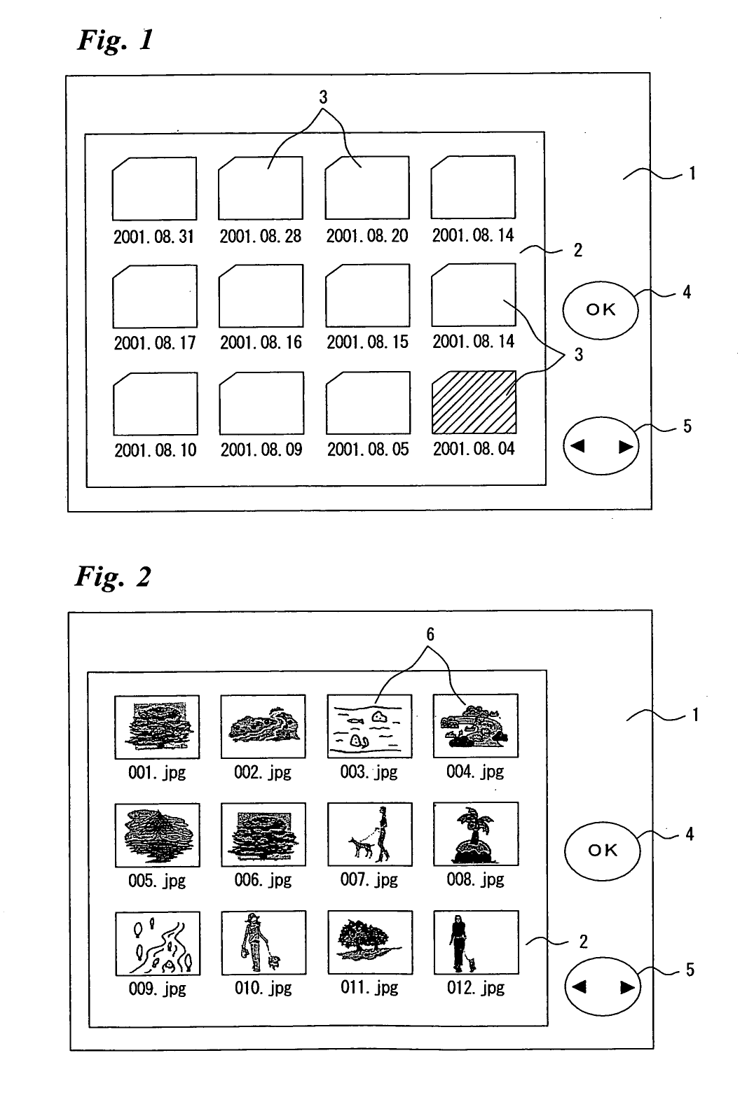

FIG. 1 illustrates the external appearance of an image display system according to a preferred embodiment of the present invention.

A display screen 2 is formed substantially over the entirety of the top surface of an image display system 1. Provided on the right side of the display screen 2 are an OK button 4 and an arrow button 5 on which left and right arrow symbols have been formed.

The image display system 1 contains a number of image files on a folder-by-folder basis. A number of folder icons 3 are being displayed on the display screen 2.

A desired folder icon 3 can be selected from the number of folder icons 3 in response to depression of the arrow button 5. The selected folder icon is indicated by hatching. The folder icon 3 to be selected is brought to the left side or right side depending upon whether the left arrow or right arrow of arrow button 5 is pressed. If the OK button 4 is pressed, reduced images of the images represented by image files contained in the folder specified by the selected folder icon 3 are displayed on the display screen 2 in a fixed size.

FIG. 2 illustrates the manner in which reduced images are displayed in an array list on the display screen 2 of image display system 1.

Although the sizes of images represented by the image files that have been stored in the image display system 1 are multifarious, reduced images 6 of a fixed size are displayed in the image display system 1 according to this embodiment.

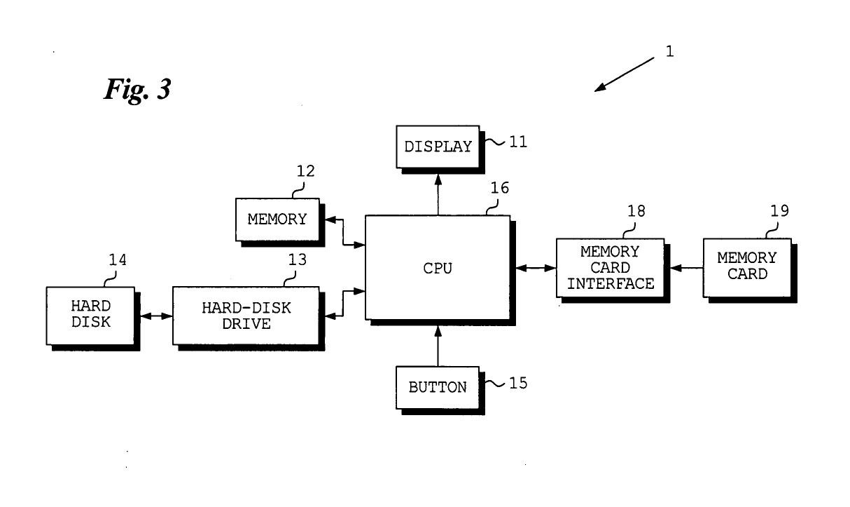

FIG. 3 is a block diagram illustrating the electrical structure of the image display system.

The overall operation of the image display system 1 is controlled by a CPU 16.

The image display system 1 includes a memory card interface 18. Image files that have been stored on a memory card 19 are read by the memory card interface 18 and stored in the image display system 1. If a program for processing image files has been stored on the memory card 19, the program is read and installed on the image display system 1, whereby the image display system 1 can also be operated in a manner described below. Naturally the program can also be installed in an image file device by some other method.

The image display system 1 is provided with the above-described OK button 4 and arrow button 5 (button 15). A command signal that is output from the button 15 is input to the CPU 16.

The image display system 1 includes a display unit 11 having the above-mentioned display screen 2, a memory 12 for storing data temporarily, a hard disk 14 for storing image files and a hard-disk drive 13.

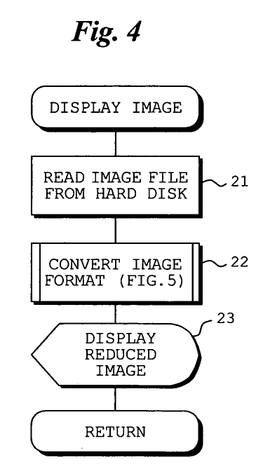

FIG. 4 is a flowchart illustrating processing for displaying an image.

An image to be displayed on the display screen 2 is selected by the user. For example, by selecting a folder icon 3 as described above and pressing the OK button 4, the images represented by the image files contained in the folder specified by the folder icon 3 are selected as images to be displayed. When an image is selected, an image file containing compressed image data corresponding to the selected image is read from the hard disk 14 (step 21). In the image display system 1 according to this embodiment, compressed image data, which has undergone encoding and orthogonal transformation based upon the JPEG (Joint Photographic Experts Group) standard in a manner described in detail later, has been stored as image files.

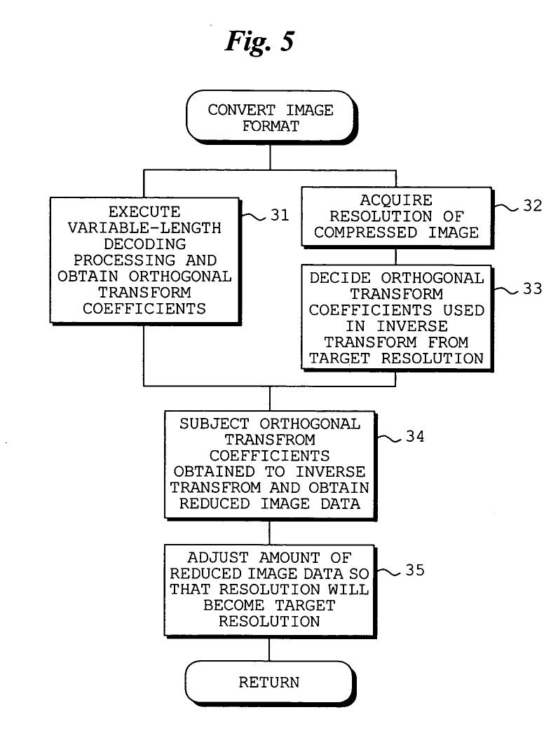

When an image file is read from the hard disk 14, the image format of the compressed image data contained in this image file is converted (step 22). Processing for decoding and for reducing the compressed image data is executed in the image format conversion. The conversion of image format will be described in detail later (see FIG. 5). The reduced image obtained by the conversion of image format is displayed on the display screen 2 (step 23), as illustrated in FIG. 2.

FIG. 5 is a flowchart illustrating the image format conversion (the processing of step 22 in FIG. 4).

When an image file is read from the hard disk 14, the compressed image data contained in this image file is read and is subjected to variable-length decoding processing, whereby orthogonal transform coefficients are obtained (step 31). The orthogonal transform coefficients are obtained with 8×8 coefficients serving as one block.

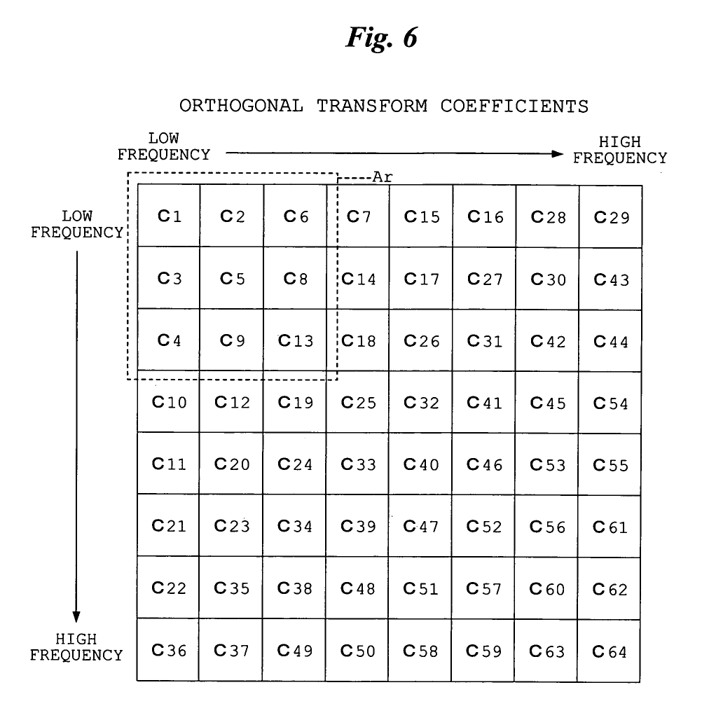

FIG. 6 illustrates an example of orthogonal transform coefficients in an 8×8 array.

One block includes 8×8=64 orthogonal transform coefficients C1 to C64. The orthogonal transform coefficients represent frequency components; the closer the coefficient is to the upper left, the lower the frequency component, the closer the coefficient is to the lower right, the higher the frequency component.

With reference again to FIG. 5, the resolution (number of pixels) of the compressed image data is acquired from the header of the image file in which this compressed image data has been stored (step 32). Next, orthogonal transform coefficients used in an inverse transform are decided from the target resolution (number of pixels) (step 33).

With reference again to FIG. 6, the orthogonal transform coefficients used in the inverse transform are those of the low-frequency components. For example, in a case where a first reduced image having a size that is ⅜ of the original image represented by the compressed image data is to be obtained, orthogonal transform coefficients C1 to C9 within a 3×3 block Ar at the upper left of the 8×8 block are decided upon as the orthogonal transform coefficients used in the inverse transform.

With reference again to FIG. 5, the orthogonal transform coefficients decided undergo an inverse transformation in an amount equivalent to one frame of an image, whereby there is obtained first reduced image data representing a first reduced image having a size that is ⅜ of the size of the original image (step 34). If the size of the obtained first reduced image is not the target size, then the amount of data constituting the first reduced image data is adjusted further in such a manner that the target resolution will be attained (step 35). The adjustment of amount of image data can make use of bicubic interpolation for calculating an image neighboring the original image and performing resizing. A second reduced image having the target size is thus obtained and can be displayed on the display screen 2 in the manner set forth above.

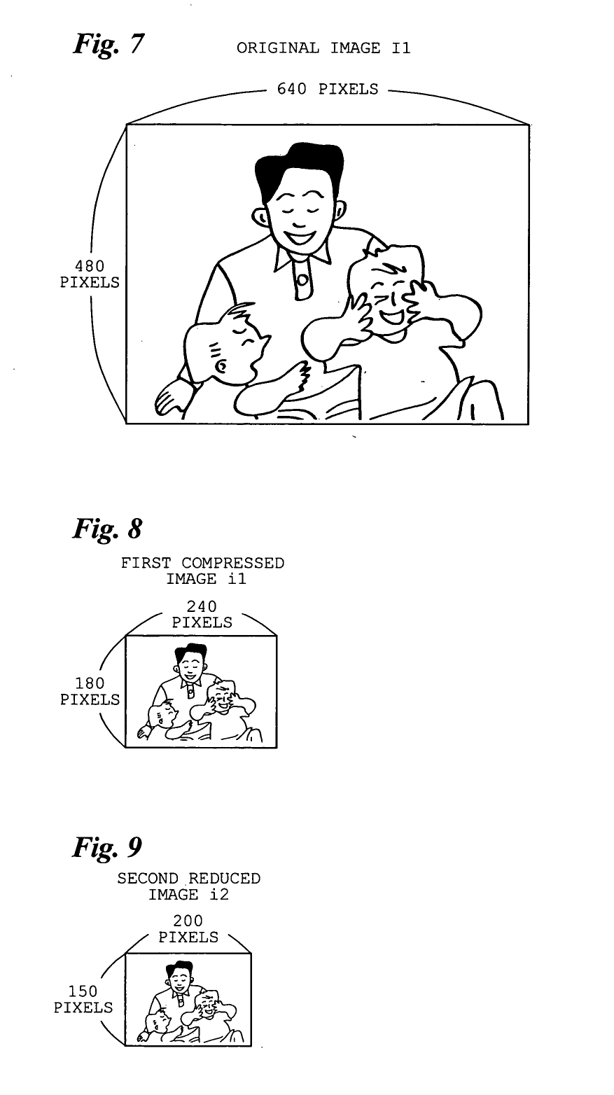

FIGS. 7 to 9 illustrate the manner in which the first and second reduced images are generated from an original image.

Assume that an original image 11 has 640 pixels horizontally and 480 pixels vertically (see FIG. 7). Assume that a reduced image (see FIG. 9) having a target size of 200 pixels horizontally and 150 pixels vertically is to be obtained from such an original image.

First, orthogonal transform coefficients are obtained in the manner set forth above by applying variable-length decoding processing to the compressed image data representing the original image. The orthogonal transform coefficients to be used in an inverse transform are decided from among the obtained orthogonal transform coefficients. Since the original image 11 has 640 pixels horizontally and 480 pixels vertically and the target reduced image (the second reduced image) i2 has 200 pixels horizontally and 150 pixels vertically, the size of the second reduced image i2 is 2.5/8 the size of the original image 11.

In a case where a reduced image is generated using some of the orthogonal transform coefficients, as described above, the only size that can be obtained is (natural number less than 8)/8. In this embodiment, therefore, first there is generated a first reduced image i1 (see FIG. 8) of 240 pixels horizontally and 180 pixels vertically, which is a size that is ⅜ the size of original image 11, using ⅜ of the orthogonal transform coefficients.

Reduction processing is further executed in such a manner that the size of the generated first reduced image i1 will become 200 pixels horizontally and 150 pixels vertically. The target second reduced image (see FIG. 9) is obtained as a result. Naturally, a first reduced image having a size that is 2/8 of the original image may be generated and this may be enlarged so as to obtained a second reduced image having the size of 2.5/8.

Thus, the first reduced image is obtained by using some and not all of the orthogonal transform coefficients in the inverse transform, and therefore the first reduced image is obtained comparatively quickly. Further, in a case where the obtained first reduced image is not the target reduced image having the desired size, reduction processing is executed further to thereby obtain the target second reduced image of the desired size.

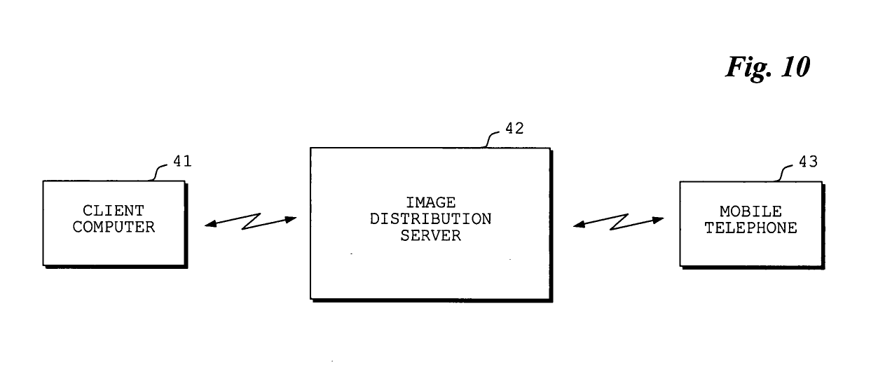

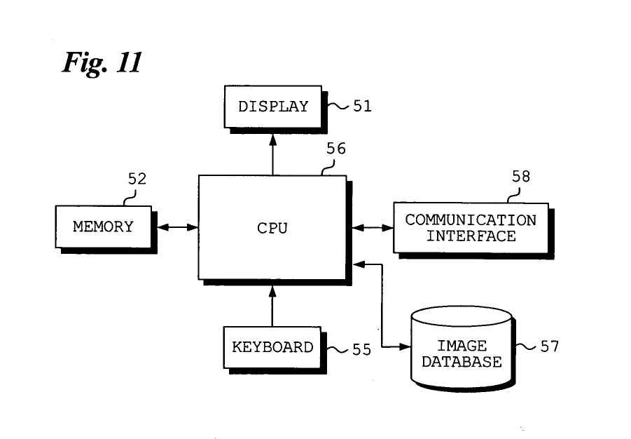

FIGS. 10 to 14 illustrate another embodiment of the invention.

FIG. 10 illustrates an overview of an image distribution system that is suitable for application to a mobile telephone.

The image distribution system includes an image distribution server 42 and a client computer 41 and mobile telephone 43 that are capable of communicating with the server 42.

In the image distribution system according to this embodiment, an image file (in which compressed image data has been stored in the manner described above) that has been generated in the client computer 41 is uploaded to and stored in the image distribution server 42. If there is a request for an image from the mobile telephone 43, the image file conforming to the request is found and, by using the processing described above, the image data is converted to a size and format suited to display on the mobile telephone 43. The image data obtained by the conversion is transmitted from the image distribution server 42 to the mobile telephone 43.

FIG. 11 is a block diagram illustrating the electrical structure of the image distribution server 42.

The overall operation of the image distribution server 42 is controlled by a CPU 56.

The image distribution server 42 includes a communication interface 58 to allow the client computer 41 and mobile telephone 43 to communicate with the image distribution server 42 as mentioned above. An image file that has been transmitted from the client computer 41 is input to the image distribution server 42 by the communication interface 58 and is stored in an image database 57. If there is an image request from the mobile telephone 43, the image file conforming to the request is read from the image database 57, a format conversion suited to display on the mobile telephone 43 is applied and the resultant image file is transmitted to the mobile telephone 43 via the communication interface 58.

The image distribution server 42 includes a keyboard 55. A command signal that is output from the keyboard 55 is input to the CPU 56. Further, the image distribution server 42 also includes a display unit 51 for displaying images and the like, and a memory 52 for storing data temporarily.

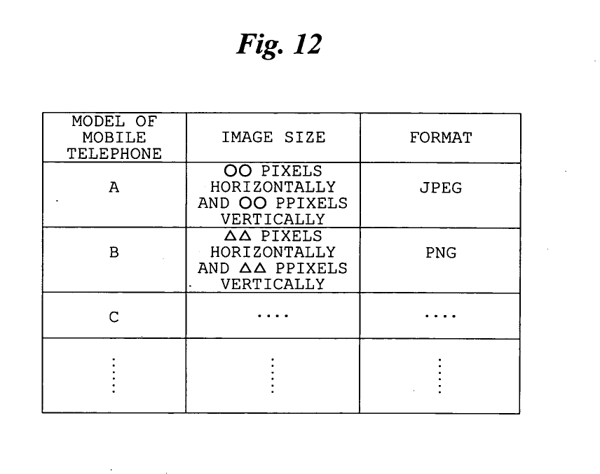

FIG. 12 illustrates an example of a table of mobile telephones. The table has been stored in the memory 52 of image distribution server 42.

The mobile telephone table is such that image size and format (image format) displayable on a mobile telephone that has transmitted an image request have been stored for every model of mobile telephone.

For example, if the model of a mobile telephone is “A”, then it will be understood that the size of an image that can be displayed on this mobile telephone is ◯◯ pixels horizontally and ◯◯ pixels vertically and that the image format is the JPEG format. Further, if the model of a mobile telephone is “B”, then it will be understood that the size of an image that can be displayed on this mobile telephone is ΔΔ pixels horizontally and ΔΔ pixels vertically and that the image format is the PNG (Portable Network Graphics) format. In accordance with the model of the mobile telephone that has transmitted an image request, reference is had to this mobile telephone table and a reduced image is generated, as will be described later, in such a manner that the image will have the appropriate image size and format.

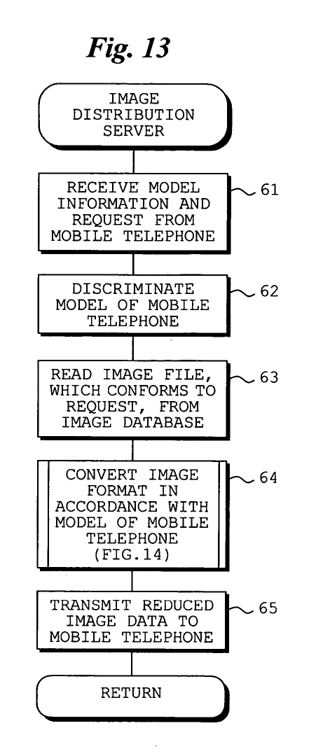

FIG. 13 is a flowchart illustrating processing executed by the image distribution server 42.

Model information concerning the mobile telephone 43 and a request are transmitted from the mobile telephone 43 to the image distribution server 42 and these are received by the image distribution server 42 (step 61). The model of the mobile telephone 43 is then discriminated (step 62). The image file conforming to the request is read from the image database 57 (step 63).

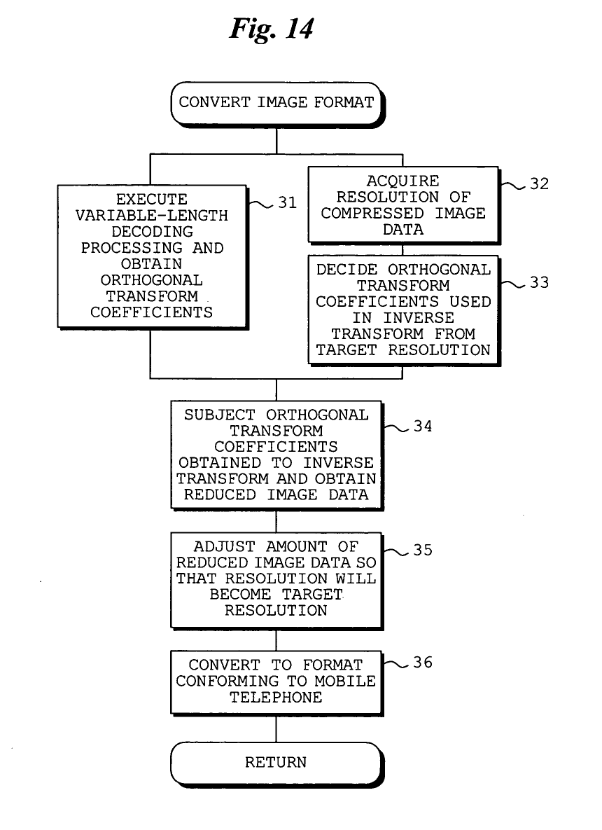

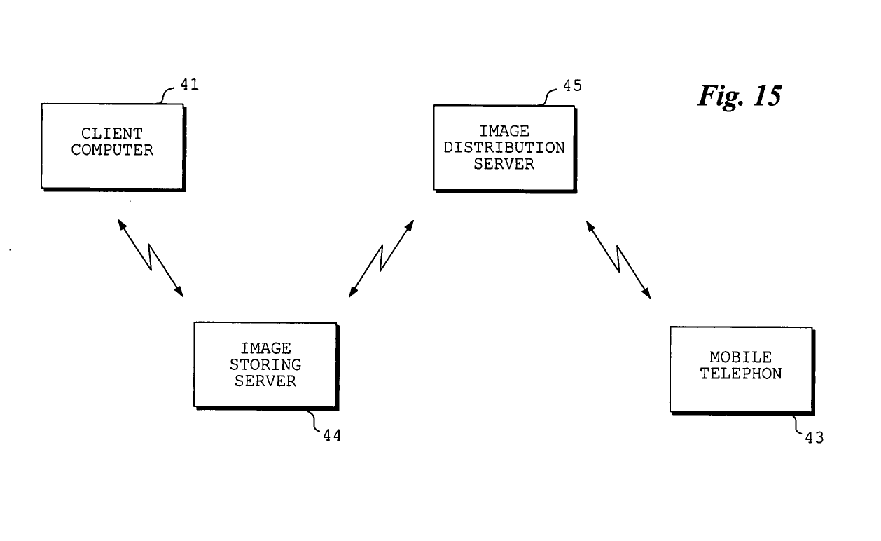

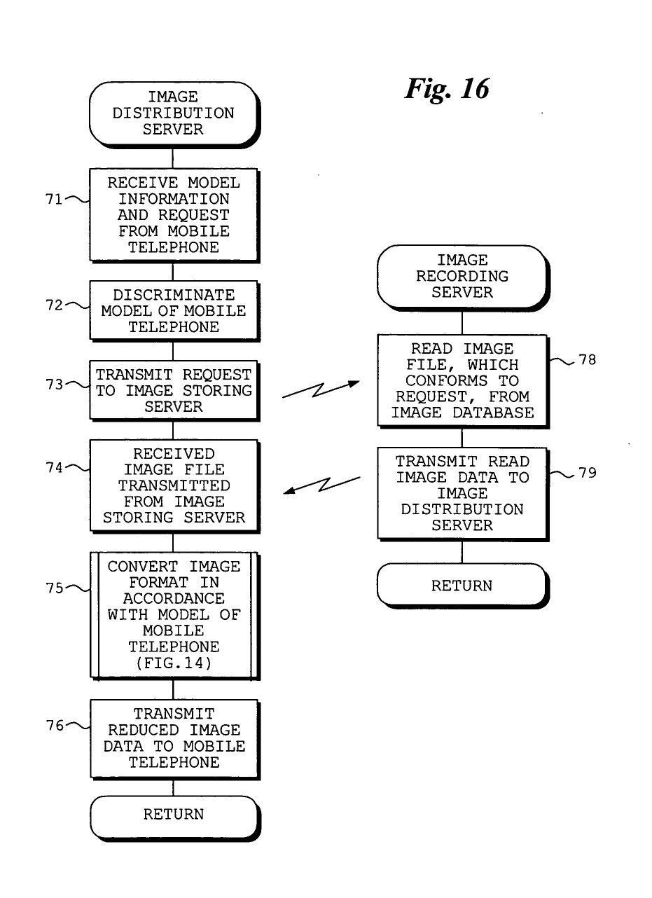

The image file that has been read from the image database 57 is converted in accordance with the model of mobile telephone so as to have the appropriate size and format (step 64). The conversion processing will be described in detail later (see FIG. 14). Reduced image data suitable for display on the mobile telephone 43 is obtained by the conversion. The obtained reduced image data is transmitted from the image distribution server 42 to the mobile telephone 43 (step 65). The appropriate reduced image is displayed quickly on the mobile telephone 43.

FIG. 14 is a flowchart illustrating processing for the image format conversion (the processing of step 64 in FIG. 13).

This processing is substantially similar to that of FIG. 5. The processing that is identical is designated by like step numbers and need not be described again.

The size (the image size in FIG. 12) of the target reduced image and the format thereof to which the conversion is to be made are ascertained in accordance with the model of mobile telephone. When the size of the target reduced image is determined, data representing the target reduced image (the second reduced image) is obtained in the manner described above from the compressed image data contained in the image file read from the image database 57 in response to the request (steps 31 to 35).

A format conversion is carried out in such a manner that the obtained reduced image data will have a format suitable for display on the mobile telephone 43 that transmitted the request (step 36). Thus, image data representing a reduced image having a size and format suited to the mobile telephone 43 is obtained and is transmitted from the image distribution server 42 to the mobile telephone 43.

Thus, an appropriate reduced image is displayed on the mobile telephone 43 comparatively quickly.

FIGS. 15 and 16 illustrate a further embodiment of the present invention.

FIG. 15 illustrates an overview of an image distribution system.

In the image distribution system described above, an image file that has been transmitted from the client computer 41 is stored in the image database 57 of the image distribution server 42. In the image distribution system according to this embodiment, however, an image file that has been transmitted from the client computer 41 is stored in an image storing server 44 that differs from an image distribution server 45. A request that has been transmitted from the mobile telephone 43 is applied to the image storing server 44 via the image distribution server 45 and an image file conforming to the request is found. The found image file is subjected to the above-described format conversion (inclusive of reduction processing) and the reduced image data is transmitted from the image distribution server 45 to the mobile telephone 43.

FIG. 16 is a flowchart illustrating the processing executed by the image distribution server 45 and image storing server 44.

Model information and a request are transmitted from the mobile telephone 43 to the image distribution server 45 and these are received by the image distribution server 45 (step 71). In a manner similar to that described above, the model of the mobile telephone 43 is discriminated (step 72) and the received request is transmitted from the image distribution server 45 to the image storing server 44 (step 73).

Upon receiving the request transmitted from the image distribution server 45, the image storing server 44 finds the image file conforming to this request (step 78). The found image file is transmitted from the image storing server 44 to the image distribution server 45 (step 79).

Upon receiving the image file transmitted from the image storing server 44 (step 74), the image distribution server 45 executes image format conversion processing, inclusive of reduction processing, in accordance with the model of the mobile telephone 43 that transmitted the request (step 75) in the manner set forth above (see FIG. 14). The reduced image data obtained by the format conversion is transmitted from the image distribution server 45 to the mobile telephone 43 (step 76).

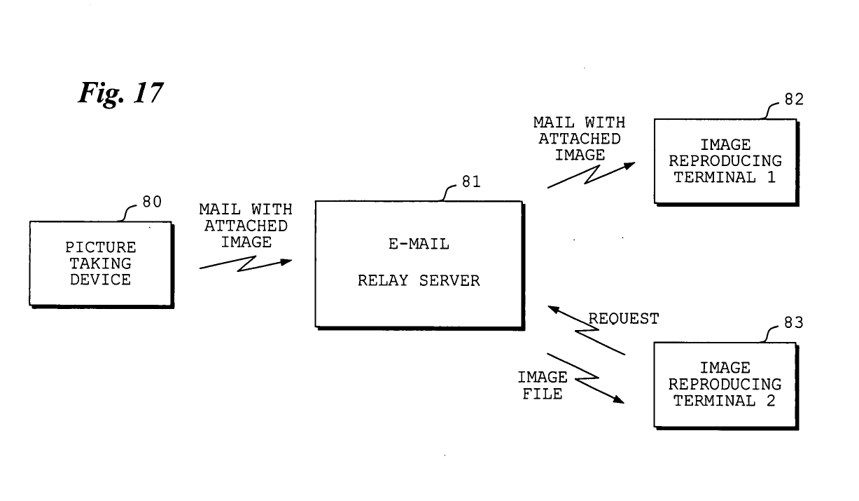

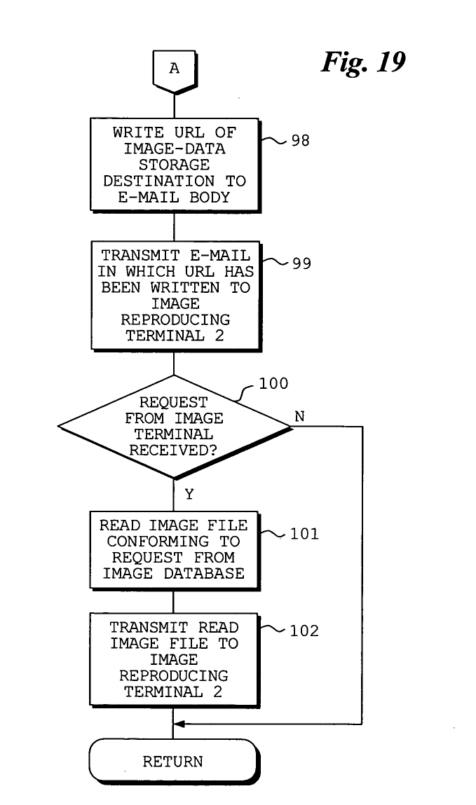

FIGS. 17 to 19 illustrate yet another embodiment of the invention.

FIG. 17 is a block diagram illustrating an overview of an e-mail distribution system.

Mail with an image attachment, namely e-mail to which an image file has been attached, is transmitted from a picture taking device 80 such as a mobile telephone to an e-mail relay server 81. Reduced image data is generated. This data has undergone reduction processing and format conversion so as to be suitable for display on an image reproducing terminal that is the transmission destination contained in the body of the e-mail of the mail having the attached image. E-mail to which the image file containing the generated reduced image data has been attached is transmitted to an image reproducing terminal 82 or 83, or the image file and the e-mail are transmitted separately to the image reproducing terminal 82 or 83.

If the transmission destination contained in the e-mail body of the mail having the attached image is the image reproducing terminal 82, which is capable of receiving the mail having the attached image, then the e-mail relay server 81 sends this image reproducing terminal 82 the e-mail having the attached image file containing the reduced image data suitable for display on the image reproducing terminal 82. If the transmission destination is the image reproducing terminal 83, which is incapable of receiving the image-attached mail, first the e-mail body is transmitted from the e-mail relay server 81 to the image reproducing terminal 83. If there is a request for the image file from the image reproducing terminal 83, then the image file is transmitted from the e-mail relay server 81 to the image reproducing terminal 83 in response to this request.

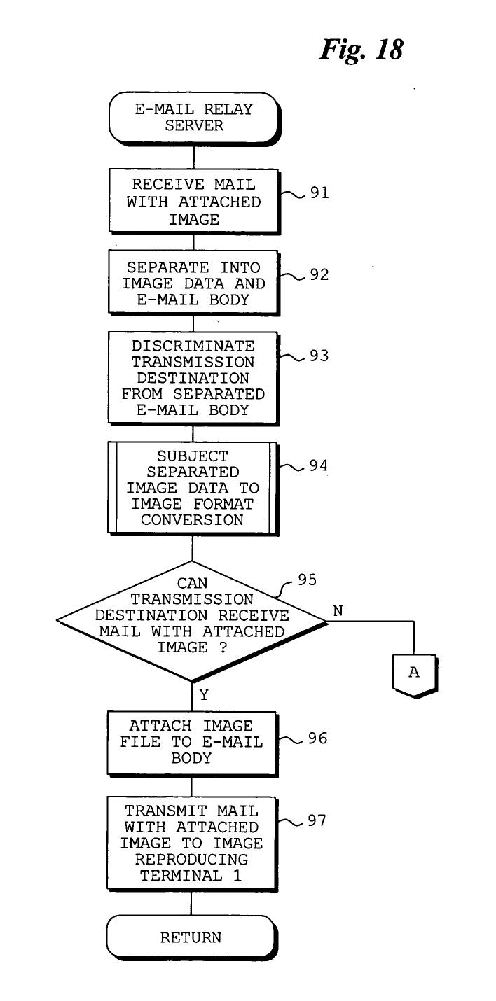

FIG. 18 is a flowchart illustrating processing executed by the e-mail relay server 81.

Mail having an attached image is transmitted from the picture taking device 80 and received by the e-mail relay server 81 (step 91). Here the attached image file and the e-mail body are separated from the received mail having the attached image (step 92).

Since the e-mail body obtained by separation contains a transmission destination, the transmission destination and the model of the device at the transmission destination are discriminated (step 93). Further, in the manner set forth above (see FIG. 5), the compressed image data contained in the separated image file is subjected to an image format conversion, inclusive of reduction processing, in accordance with the model at the transmission destination in such a manner that an image having the appropriate size and format will be obtained (step 94).

If the transmission destination can receive mail having an attached image, as is the case with the image reproducing terminal 82 (“YES” at step 95), then the image file containing the reduced image data that has undergone the image format conversion is attached to the e-mail body obtained by separation (step 96). The e-mail with the attached image file is transmitted to the image reproducing terminal 82 (step 97). By thus receiving the mail having the attached image, the image reproducing terminal 82 can rapidly display the reduced image represented by the image file that has been attached to the e-mail.

If the transmission destination cannot receive mail having an attached image, as is the case with the image reproducing terminal 83 (“NO” at step 95), then the URL of the storage destination of the image data is written into the body of the e-mail (step 98). The e-mail body in which the URL has thus been written is transmitted from the e-mail relay server 81 to the image reproducing terminal 83 (step 99).

When the image reproducing terminal 83 receives the e-mail body in which the URL has been written and the user of this terminal who has read the e-mail accesses the written URL, the image reproducing terminal 83 transmits the request for the image file to the e-mail relay server 81.

The request transmitted from the image reproducing terminal 83 is transmitted to the e-mail relay server 81. When the request is received by the e-mail relay server 81 (“YES” at step 100), the image file conforming to the request is read out of the image database of e-mail relay server 81 (the image file containing the reduced image data that has undergone reduction processing and format conversion in the manner described above has been stored in correspondence with the URL) (step 101). It goes without saying that the image database may be provided as an image storing server separate from the e-mail relay server 81. The image file that has been read from the image database is transmitted to the image reproducing terminal 83 that transmitted the request (step 102). This means that even if the terminal is the image reproducing terminal 83 that cannot mail having an attached image, a reduced image suitable for display on the image reproducing terminal 83 can be displayed comparatively quickly.

The image data contained in the image file that has been attached to the e-mail transmitted from the picture taking device 80 is not limited to compressed image data representing a JPEG-compliant still picture or the like and may be compressed image data representing an MPEG-compliant moving picture, etc. Even if an image file containing image data representing a moving picture has been attached, the file can be handled in the manner described above. Specifically, the file can be subjected to reduction processing and format conversion processing and, in accordance with the image reproducing terminal at the transmission destination, e-mail having the attached image file storing the reduced moving-picture data can be transmitted or the image file containing the reduced moving-picture data can be transmitted in response to a request.

Though the above-described embodiments are implemented using software, it goes without saying that the embodiments can be implemented using hardware.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for decoding and reducing an image, comprising:
a variable-length decoding processing device for inputting compressed image data that has undergone an orthogonal transformation and variable-length encoding, applying variable-length decoding processing to this data and obtaining orthogonal transform coefficients;
an orthogonal transform coefficient deciding device for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by said variable-length decoding processing device;
an inverse orthogonal transform device for executing inverse orthogonal transform processing and obtaining reduced image data using the orthogonal transform coefficients decided by said orthogonal transform coefficient deciding device; and
an adjusting device for adjusting amount of the reduced image data in such a manner that the size of the reduced image data represented by the reduced image data obtained by said inverse orthogonal transform device will become the image size to which a reduction is to be made.

2. An image distribution server comprising:
a compressed image data search device, which is responsive to model information of a mobile terminal and an image data request that have been transmitted from the mobile terminal, for finding corresponding compressed image data in compressed image data that has undergone an orthogonal transformation and variable-length encoding, this being image data, which is to be transmitted to the mobile terminal, stored in a compressed image data storage device;
a variable-length decoding processing device for inputting the compressed image data that has been found by said compressed image data search device, applying variable-length decoding processing to this data and obtaining orthogonal transform coefficients;
an orthogonal transform coefficient deciding device for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by said variable-length decoding processing device;
an inverse orthogonal transform device for executing inverse orthogonal transform processing and obtaining reduced image data using the orthogonal transform coefficients decided by said orthogonal transform coefficient deciding device;
an adjusting device for adjusting amount of the reduced image data in such a manner that the size of the reduced image data represented by the reduced image data obtained by said inverse orthogonal transform device will become the image size to which a reduction is to be made; and
an image data transmitting device for transmitting the reduced image data, the amount of which has been adjusted by said adjusting device, to the mobile terminal that transmitted the image data request.

3. The server according to claim 2, wherein said compressed image data storage device is provided separately of said image distribution server.

4. A server for relaying mail having an image attachment, comprising:
a separating device for receiving e-mail transmitted from a mobile terminal and to which has been attached compressed image data that has undergone an orthogonal transformation and variable-length encoding, and separating the e-mail into the attached compressed image data and an e-mail body;
a variable-length decoding processing device for inputting the compressed image data that has been separated by said separating device, applying variable-length decoding processing to this data and obtaining orthogonal transform coefficients;
an orthogonal transform coefficient deciding device for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by said variable-length decoding processing device;
an inverse orthogonal transform device for executing inverse orthogonal transform processing and obtaining reduced image data using the orthogonal transform coefficients decided by said orthogonal transform coefficient deciding device;
an adjusting device for adjusting amount of the reduced image data in such a manner that the size of the reduced image data represented by the reduced image data obtained by said inverse orthogonal transform device will become the image size to which a reduction is to be made; and
an e-mail transmitting device for transmitting the reduced image data, the amount of which has been adjusted by said adjusting device, and the e-mail body separated by said separating device to a transmission destination contained in the e-mail body.

5. The server according to claim 4, wherein said e-mail transmitting device transmits the reduced image data obtained by said inverse orthogonal transform device to the transmission destination contained in the e-mail body upon attaching the reduced image data to the e-mail body separated by said separating device, or transmits the e-mail body to the transmission destination contained in the e-mail body separated by said separating device and transmits the reduced image data obtained by the inverse orthogonal transform to the transmission destination in response to a request from the transmission destination.

6. The server according to claim 5, wherein the reduced image data is reduced image data representing a moving picture.

7. An image display system comprising:
a compressed image data storage device for storing a plurality of items of compressed image data that have undergone an orthogonal transformation and variable-length encoding;
a compressed image data search device, which is responsive to an image display command, for finding corresponding compressed image data in compressed image data that has been stored in said compressed image data storage device;
a variable-length decoding processing device for inputting the compressed image data that has been found by the compressed image data search device, applying variable-length decoding processing to this data and obtaining orthogonal transform coefficients;
an orthogonal transform coefficient deciding device for deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing by said variable-length decoding processing device;
an inverse orthogonal transform device for executing inverse orthogonal transform processing and obtaining reduced image data using the orthogonal transform coefficients decided by said orthogonal transform coefficient deciding device;
an adjusting device for adjusting amount of the reduced image data in such a manner that the size of the reduced image data represented by the reduced image data obtained by said inverse orthogonal transform device will become the image size to which a reduction is to be made; and
a display device for displaying the reduced image represented by the reduced image data obtained by said adjusting device.

8. A method of decoding and reducing an image, comprising the steps of:
inputting compressed image data that has undergone an orthogonal transformation and variable-length encoding, applying variable-length decoding processing to this data and obtaining orthogonal transform coefficients;
deciding orthogonal transform coefficients of low-frequency components to be used in an inverse orthogonal transform, based upon size of an image represented by the input compressed image data and an image size to which a reduction is to be made, from among the orthogonal transform coefficients obtained in the variable-length decoding processing;
executing inverse orthogonal transform processing and obtaining reduced image data using the decided orthogonal transform coefficients; and
adjusting amount of the reduced image data in such a manner that the size of the reduced image data represented by the reduced image data obtained in the inverse orthogonal transform processing will become the image size to which a reduction is to be made.
